(19) United States
(12) Patent Application Publication
(10) Pub. No.: US 2026/0169301 A1
(43) Pub. Date: Jun. 18, 2026

(54) Electronic Devices With Optical Assembly Position Sensors

(71) Applicant: Apple Inc., Cupertino, CA (US)

(72) Inventors: Hiroshi Kubo, Santa Clara, CA (US); Matin Seadat Beheshti, Sunnyvale, CA (US)

(21) Appl. No.: 19/375,066

(22) Filed: Oct. 30, 2025

Related U.S. Application Data
(60) Provisional application No. 63/734,673, filed on Dec. 16, 2024.

(51) Int. Cl. G02B 27/01

(52) U.S. Cl. CPC G02B 27/0176; G02B 27/0172; G02B 2027/015; G02B 2027/0154; G02B 2027/0161

(57) ABSTRACT

A head-mounted device may include optical assemblies for presenting images to a user. Each optical assembly may have a support configured to support a display, a lens through which an image from the display is presented to an eye box for viewing, and a sensor. Each support may have an opening configured to receive a guide rod along which the support slides to adjust where the optical assembly is positioned along that guide rod. Each guide rod, or another fixed portion of the head-mounted device may include at least a portion of a position sensor. The position sensor may be a potentiometer, a pressure sensor, a magnetic encoder, an optical sensor, and/or a pneumatic pressure sensor, as examples. The position sensor may measure a position of the optical assembly relative to the guide rod.

This application claims the benefit of U.S. provisional patent application No. 63/734,673, filed December 16, 2024, which is hereby incorporated by reference herein in its entirety.

### FIELD

This relates generally to electronic devices, including head-mounted devices.

### BACKGROUND

Electronic devices have components such as displays and lenses. It can be challenging to customize such devices for different users.

### SUMMARY

A head-mounted device may include optical assemblies for presenting images to a user. To accommodate users with different interpupillary distances, the optical assemblies may be moved together or apart.

Each optical assembly may have a support configured to support a display, a lens through which an image from the display is presented to an eye box for viewing, and a sensor. Each support may have an opening configured to receive a guide rod along which the support slides.

Each guide rod of the head-mounted device may include at least a portion of a position sensor. The position sensor may be a potentiometer, a pressure sensor, a magnetic encoder, an optical sensor, and/or a pneumatic pressure sensor, as examples. The position sensor may measure a position of the optical assembly relative to the guide rod.

Alternatively or additionally, a position sensor may be formed between on another fixed portion of the head-mounted device, such as on a chassis of a housing of the head-mounted device.

### BRIEF DESCRIPTION OF THE DRAWINGS

FIG. 1 is a diagram of an illustrative head-mounted device in accordance with some embodiments.

FIG. 2 is a top view of an illustrative optical assembly and guide rod having a position sensor in accordance with some embodiments.

FIGS. 3A and 3B are views of an illustrative potentiometer that may be used to determine a position of an optical assembly relative to a guide rod in accordance with some embodiments.

FIGS. 4A and 4B are views of an illustrative pressure sensor that may be used to determine a position of an optical assembly relative to a guide rod in accordance with some embodiments.

FIGS. 5A and 5B are views of an illustrative magnetic encoder that may be used to determine a position of an optical assembly relative to a guide rod in accordance with some embodiments.

FIGS. 6A and 6B are views of an illustrative optical sensor that may be used to determine a position of an optical assembly relative to a guide rod in accordance with some embodiments.

FIGS. 7A and 7B are views of an illustrative pneumatic pressure sensor that may be used to determine a position of an optical assembly relative to a guide rod in accordance with some embodiments.

FIG. 8 is a top view of an illustrative head-mounted device having an optical assembly and guide rod, and a position sensor in a fixed portion of a housing in accordance with some embodiments.

### DETAILED DESCRIPTION

Electronic devices such as head-mounted devices may have displays for displaying images and lenses that are used in presenting the images to eye boxes for viewing by a user. Different users have different spacings between their eyes, which are sometimes referred to as interpupillary distances. To accommodate users with different interpupillary distances, a head-mounted device may be provided with movable optical assemblies.

A head-mounted device may have position sensors to measure the positions of the optical assemblies. This information may be used to accurately control the separation between the optical assemblies. In an illustrative embodiment, the optical assemblies may slide along guide rods during positioning operations and the position sensors may make position measurements. To reduce the space needed for the position sensors, the position sensors may be at least partially integrated into the guide rods. As examples, a potentiometer, pressure sensor, magnetic encoder, optical sensor, and/or other suitable position sensor(s) may be incorporated into each guide rod to determine the movement of the optical assemblies along the guide rod.

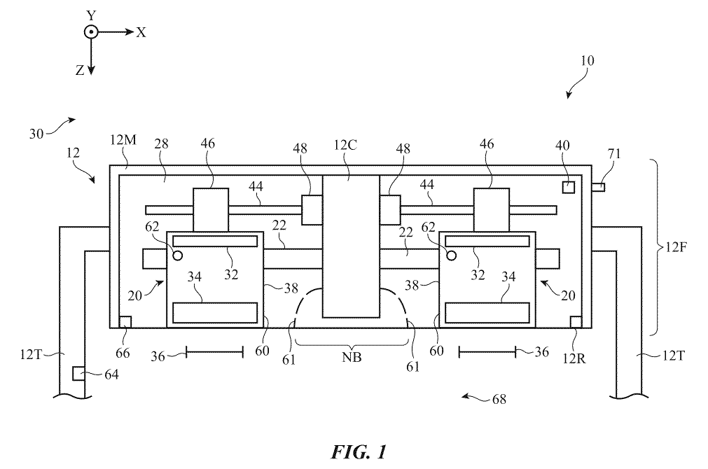

FIG. 1 is a schematic diagram of an illustrative electronic device of the type that may include movable optical assemblies to accommodate different interpupillary distances. Device 10 of FIG. 1 may be a head-mounted device, such as goggles, glasses, a helmet, and/or another head-mounted device. In an illustrative configuration, device 10 is a head-mounted device such as a pair of goggles (sometimes referred to as virtual reality goggles, mixed reality goggles, augmented reality glasses, etc.).

As shown in the illustrative cross-sectional top view of device 10 of FIG. 1, device 10 may have a housing such as housing 12 (sometimes referred to as a head-mounted support structure, head-mounted housing, or head-mounted support). Housing 12 may include a front portion such as front portion 12F and a rear portion such as rear portion 12R. When device 10 is worn on the head of a user, rear portion 12R rests against the face of the user and helps block stray light from reaching the eyes of the user and nose bridge portion NB of housing 12 rests on the nose of the user.

Main portion 12M of housing 12 may be attached to head strap 12T. Head strap 12T may be used to help mount main portion 12M on the head and face of a user. Main portion 12M may have a rigid shell formed from housing walls of polymer, glass, metal, and/or other materials. When housing 12 is being worn on the head of a user, the front of housing 12 may face outwardly away from the user, the rear of housing 12 (and rear portion 12R) may face towards the user. In this configuration, rear portion 12R may face the user’s eyes located in eye boxes 36.

Device 10 may have electrical and optical components that are used in displaying images to eye boxes 36 when device 10 is being worn. These components may include left and right optical assemblies 20 (sometimes referred to as optical modules 20). Each optical assembly 20 may have an optical assembly support 38 (sometimes referred to as a lens barrel, optical module support, lens support, lens and display support, support, or support structure) and guide rods 22 (sometimes referred to as guide rails 22) along which optical assemblies 20 may slide to adjust optical-assembly-to-optical-assembly separation to accommodate different user interpupillary distances. Guide rods 22 may be cylindrical (e.g., guide rods 22 may have circular cross-sectional shapes) or may have other suitable shapes (e.g., guide rods 22 may have cross-sectional shapes that are triangular, rectangular, hexagonal, semi-circular, etc.). Cylindrical guide rods are sometimes described herein as an example.

Each assembly 20 may have a display 32 that has an array of pixels for displaying images and a lens 34. Lens 34 may optionally have a removable vision correction lens for correcting user vision defects (e.g., refractive errors such as nearsightedness, farsightedness, and/or astigmatism). In each assembly 20, display 32 and lens 34 may be coupled to and supported by support 38. During operation, images displayed by displays 32 may be presented to eye boxes 36 through lenses 34 for viewing by the user. Although each optical assembly 20 is shown as having a dedicated display 32 and lens 34, this is merely illustrative. In some embodiments, a single display may be viewed by both the left and right eyes of the user through dedicated optical assemblies for the left and right eyes.

Rear portion 12R may include flexible structures (e.g., a flexible polymer layer, a flexible fabric layer, and/or other flexible housing structures) so that portion 12R can stretch to accommodate movement of supports 38 toward and away from each other to accommodate different user interpupillary distances. Alternatively or additionally, rear portion 12R may include rigid or stiff portions, such as metal, plastic, and/or other portions.

The walls of housing 12 may separate interior region 28 within device 10 from exterior region 30 surrounding device 10. In interior region 28, optical assemblies 20 may be mounted on guide rods 22. Supports 38 may have openings that receive guide rods 22 and that allow supports 38 and assemblies 20 to slide along guide rods 22 to adjust the spacing between assemblies 20. In some embodiments, for example, each support 38 may have a hanger with a through opening that allows one of guide rods 22 to pass and to maintain a position of support 38.

Each guide rod 22 may be formed from a hollow cylindrical tube with a circular cross-sectional shape, a hollow tube of other cross-sectional shape (triangular, rectangular, hexagonal, semi-circular, etc.), or a solid rod (e.g., a solid cylindrical bar or a solid bar with other suitable shapes). Each guide rod 22 may be formed from fiber-composite material (e.g., guide rod 22 may be a fiberglass rod or carbon-fiber rod formed from epoxy or other polymer filled with fibers such as glass fibers or carbon fibers), may be formed from polymer (e.g., polymer without embedded fibers), may be formed from ceramic, glass, metal, natural materials such as wood, other materials, and/or combinations of these materials.

There may be one or more guide rods 22 for each support 38 (e.g., each support may receive upper and lower guide rods 22, or each support may receive a single guide rod). Guide rods 22 may be attached to central housing portion 12C. If desired, the outer ends of guide rods 22 may be unsupported (e.g., the outer end portions of guide rods 22 may not directly contact housing 12, so that these ends float in interior region 28 with respect to housing 12). However, the outer ends of guide rods 22 may be supported, if desired.

Device 10 may include control circuitry and other components such as components 40. The control circuitry may include storage, processing circuitry formed from one or more microprocessors and/or other circuits. The control circuitry may be used to control any adjustable components in device 10 such as motors, actuators, displays, light-emitting components, audio components, etc. To support communications between device 10 and external equipment, the control circuitry may include wireless communications circuitry. Components 40 may include sensors such as such as force sensors (e.g., strain gauges, capacitive force sensors, resistive force sensors, etc.), audio sensors such as microphones, touch and/or proximity sensors such as capacitive sensors, optical sensors such as optical sensors that emit and detect light, ultrasonic sensors, and/or other touch sensors and/or proximity sensors, monochromatic and color ambient light sensors, image sensors, sensors for detecting position, orientation, and/or motion (e.g., accelerometers, magnetic sensors such as compass sensors, gyroscopes, and/or sensors such as inertial measurement units that contain some or all of these sensors), radio-frequency sensors, depth sensors (e.g., structured light sensors and/or depth sensors based on stereo imaging devices), optical sensors such as self-mixing sensors and light detection and ranging (lidar) sensors that gather time-of-flight measurements, humidity sensors, moisture sensors, visual inertial odometry sensors, current sensors, voltage sensors, and/or other sensors. In some arrangements, device 10 may use sensors to gather user input (e.g., button press input, touch input, etc.). Sensors may also be used in gathering environmental measurements (e.g., device motion measurements, temperature measurements, ambient light readings, etc.).

Optical assemblies 20 may have gaze trackers 62 (sometimes referred to as gaze tracker sensors). Gaze trackers 62, which may operate through lenses 34, may include one or more light sources such as infrared light-emitting diodes that emit infrared light to illuminate the eyes of a user in eye boxes 36. Gaze trackers 62 also include infrared cameras for capturing images of the user’s eyes and measuring reflections (glints) of infrared light from each of the infrared light sources. By processing these eye images, gaze trackers 62 may track the user’s eyes and determine the point-of-gaze of the user. Gaze trackers 62 may also measure the locations of the user’s eyes (e.g., the user’s eye relief and the user’s interpupillary distance).

To accommodate users with different interpupillary distances (eye-to-eye spacings), the spacing between the left and right optical assemblies 20 in device 10 can be adjusted (e.g., to match or nearly match the user’s measured interpupillary distance). Device 10 may have left and right actuators (e.g., motors) such as motors 48. Each motor 48, which may include internal gears, may be used to rotate an elongated threaded shaft (screw) such as shaft 44. A nut 46 may be provided on each shaft 44. The nut, which may, if desired, be formed from part of support 38, has threads that engage the threads on that shaft 44. When a shaft is rotated, the nut on the shaft is driven in a +X or -X direction (in accordance with whether the shaft is being rotated clockwise or counterclockwise). In turn, this moves the optical assembly 20 that is attached to the nut in the +X or -X direction along its optical assembly guide rod 22. Each assembly 20 (e.g., support 38) may have a portion that forms a cylindrical opening or other suitable structure that receives one of guide rods 22 so that the assembly is guided along the guide rod. By controlling the activity of motors 48, the spacing between the left and right optical assemblies of device 10 may be changed so that interpupillary distance adjustments can be made to device 10 to accommodate the interpupillary distances of different users. For example, if a user has closely spaced eyes, assemblies 20 may be moved inwardly (towards each other and towards nose bridge portion NB of housing 12) and if a user has widely spaced eyes, assemblies 20 may be moved outwardly (away from each other).

Although FIG. 1 shows motors 48 coupled to shafts 44, this is merely illustrative. In some embodiments, motors 48 may be coupled to guide rods 22. Alternatively or additionally, a single motor 48 may be used to adjust both the left and right optical assemblies 20.

When device 10 is being worn by a user, the user’s head is located in region 68. The presence of the user’s head (and therefore a determination of whether device 10 is being worn or is unworn) may be made using one or more sensors (e.g., gaze trackers 62, which may detect the presence of the eyes of the user in eye boxes 36, rear-facing sensors such as sensor 66 on main portion 12M, head-facing sensors mounted on strap 12T such as sensor 64, and/or other head presence sensors). These sensors may include cameras, light sensors (e.g., visible light or infrared sensors that measure when ambient light levels have dropped due to shadowing by the head of a user), proximity sensors (e.g., sensors that emit light such as infrared light and that measure corresponding reflected light from a user’s head with an infrared light sensor, capacitive proximity sensors, ultrasonic acoustic proximity sensors, etc.), switches and/or other force-sensing sensors that detect head pressure when a user’s head is present, and/or other head presence sensors.

Output from head presence sensors, sensors that measure the presence of the user’s nose in nose bridge NB, and/or output from gaze trackers 62 may be used in controlling motors 48 to automatically adjust the spacing of optical assemblies 20. Optical assembly spacing may also be adjusted manually (e.g., by controlling motors 48 using a button such as button 71).

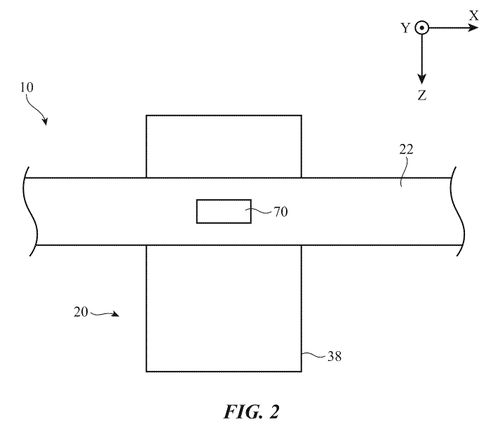

FIG. 2 is a top view of an interior portion of device 10 showing how support 38 of each optical assembly 20 may have an opening that receives a corresponding guide rod 22. A position sensor that measures the position of assembly 20 (e.g., that measures the position of support 38 relative to guide rod 22) may be formed using sensor 70 at least partially incorporated into and/or onto guide rod 22.

Sensor 70 may be a potentiometer in guide rod 22, and the potentiometer may have a spring coupled to support 38. As support 38 moves relative to guide rod 22, the potential measured by the potentiometer will change, and the position of support 38 may be determined based on the changes in potential. In this way, the position of support 38 relative to guide rod 22 may be measured.

Alternatively, sensor 70 may include a pressure sensor that measures a corresponding leaf spring or other protrusion on support 38, a magnetic encoder that measures one or more corresponding magnets on support 38, an optical sensor that measures one or more corresponding optical patterns on support 38, a pneumatic pressure sensor that measures changes in pressure in a sealed tube surrounding the guide rod, and/or any other suitable sensors.

Sensor 70 may be a relative position sensor, an absolute position sensor, or a hybrid position sensor (e.g., a position sensor that gives both relative sensor measurements and absolute sensor measurements at different positions of support 38 relative to guide rod 22).

By incorporating sensor 70 at least partially into guide rod 22, the size of guide rod 22 may be reduced/minimized. For example, guide rod 22 may have a diameter (or other thickness depending on the shape of guide rod 22) of 1 mm or less, of 2 mm or less, or of 3 mm or less, as examples. In general, however, guide rod 22 may have any suitable diameter/thickness, such as a thickness of greater than 1 mm.

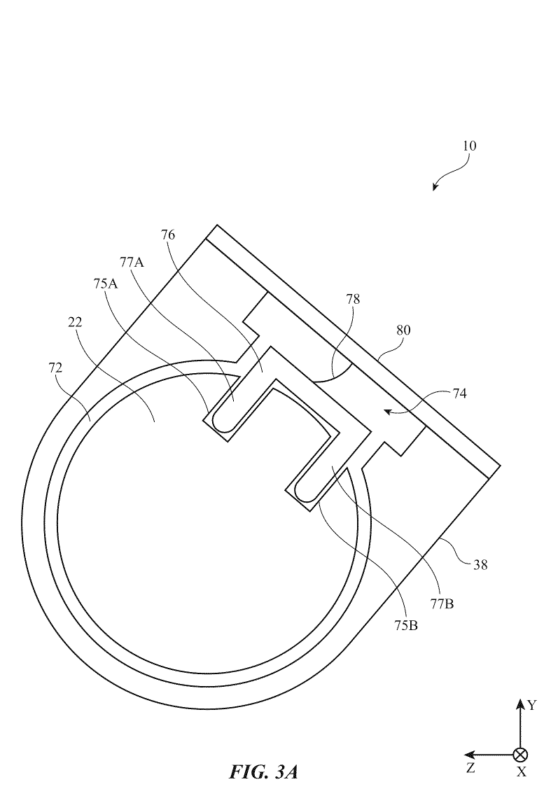

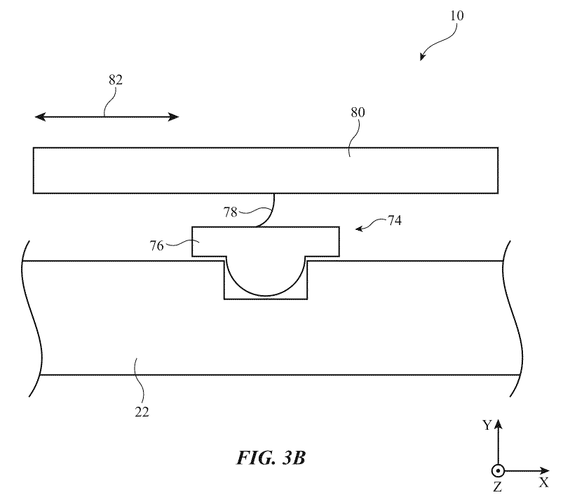

An illustrative example of a potentiometer that may be used to determine the position of an optical module relative to a guide rod is shown in FIG. 3A. In particular, FIG. 3A is a side view (and/or a cross-sectional side view) of an interior portion of device 10 showing guide rod 22 in opening 72 of support 38. Potentiometer 74 may be formed in and/or on guide rod 22.

Potentiometer 74 may include fixed portion 76 coupled to (e.g., fixed to) guide rod 22. For example, guide rod 22 may have one or more grooves, such as grooves 75A and 75B. Fixed portion 76 may include one or more extensions, such as extensions 77A and 77B, that extend into and that are coupled to each groove. Extensions 77 may be coupled to grooves 75 of guide rod 22 using adhesive, may be press-fit into grooves 75, or may be otherwise attached to guide rod 22 within grooves 75.

Fixed portion 76 may include a resistor, such as a resistive strip. Potentiometer 74 may also include wiper 78, which may include a spring, such as a copper spring. In some embodiments, the spring of wiper 78 may allow wiper 78 to move across a surface of fixed portion 76 while in contact with the surface. However, this is merely illustrative. In general, wiper 78 may include any suitable material(s).

Wiper 78 may be attached to circuit board 80, which may be a printed circuit board (PCB), a flexible PCB, and/or another suitable circuit board. Circuit board 80 may be attached to support 38 using adhesive or another suitable attachment.

In operation, as support 38 (and optical module 20 of FIGS. 1 and 2) moves relative to guide rod 22, wiper 78 may move across fixed portion 76. Because fixed portion 76 includes a resistor, a potential may be measured by wiper 78 (e.g., using circuitry on circuit board 80 and/or other suitable circuitry). Based on the measured potential (e.g., changes in the potential), a position of support 38 (and optical module 20) relative to guide rod 22 may be determined. An illustrative front view showing the relationship between support 38, guide rod 22, and potentiometer 74 is shown in FIG. 3B.

As shown in FIG. 3B, circuit board 80, which is coupled to support 38 (FIG. 3A), may move in directions 82 relative to guide rod 22. Directions 82 may correspond with the +X and -X directions. As circuit board 80 and support 38 move in directions 82, wiper 78 may move across the surface of fixed portion 76. Because fixed portion 76 includes a resistor, a potential may be measured by wiper 78 (e.g., using circuitry on circuit board 80 and/or other suitable circuitry). Based on the measured potential (e.g., changes in the potential), a position of support 38 (and optical module 20 of FIGS. 1 and 2) relative to guide rod 22 may be determined. In this way, a potentiometer formed on/in guide rod 22 may be used to determine a position of an optical module relative to the guide rod.

Although FIGS. 3A and 3B show a single fixed portion 76 of potentiometer 74, this is merely illustrative. Multiple fixed portions 76 with resistors may be formed along guide rod 22, if desired.

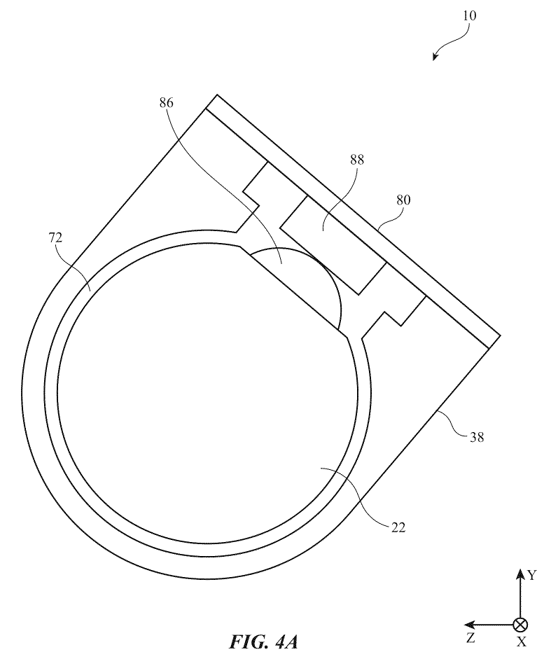

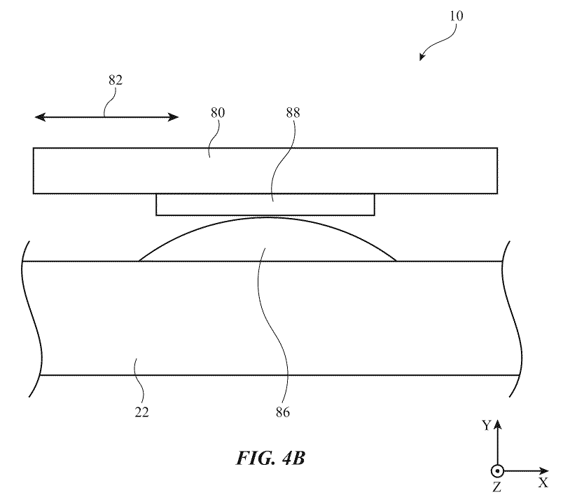

In some embodiments, instead of or in addition to measuring the position of an optical module relative to a guide rod using a potentiometer, a pressure sensor may be used. An illustrative example is shown in FIG. 4A.

FIG. 4A is a side view (and/or a cross-sectional side view) of an interior portion of device 10 showing guide rod 22 in opening 72 of support 38. Pressure sensor 88 may be used to determine a support 38 relative to guide rod 22. In particular, pressure sensor 88 may be coupled to circuit board 80. Pressure sensor 88 may be a strain gauge or other suitable pressure sensor. Corresponding protrusion 86 may be coupled to guide rod 22. Protrusion 86 may be a spring, such as a leaf spring, or another desired protrusion. In some embodiments, protrusion 86 may be compliant (e.g., flexible) to allow pressure sensor 88 to move over protrusion 86. However, protrusion 86 may be rigid or stiff, if desired. Protrusion 86 may be coupled to a surface of guide rod 22, such as using adhesive or another suitable attachment, or may be formed integrally with guide rod 22 on the surface.

In operation, as support 38 (and optical module 20 of FIGS. 1 and 2) moves relative to guide rod 22, pressure sensor 88 may move across protrusion 86. Pressure changes (e.g., strain) may be measured by pressure sensor 88. Based on the measured pressure changes, a position of support 38 (and optical module 20) relative to guide rod 22 may be determined. An illustrative front view showing the relationship between support 38, guide rod 22, and pressure sensor 88 is shown in FIG. 4B.

As shown in FIG. 4B, circuit board 80, which is coupled to support 38 (FIG. 3A), may move in directions 82 relative to guide rod 22. Directions 82 may correspond with the +X and -X directions. As circuit board 80 and support 38 move in directions 82, pressure sensor 88 may move across the surface of protrusion 86. As pressure sensor 88 moves across protrusion 86, the pressure (e.g., strain) measured by pressure sensor 88 will change based on the location of pressure sensor 88 relative to protrusion 86. Based on the measured pressure (e.g., changes in the pressure), a position of support 38 (and optical module 20 of FIGS. 1 and 2) relative to guide rod 22 may be determined. In this way, a pressure sensor may be used to determine a position of an optical module relative to the guide rod.

Although FIGS. 4A and 4B show a single protrusion 86 on guide rod 22, this is merely illustrative. Multiple protrusions 86 may be formed along guide rod 22 to be sensed by pressure sensor 88, if desired. Alternatively or additionally, multiple pressure sensors, such as pressure sensor 88, may be formed on circuit board 80 and/or otherwise be coupled to support 38 to determine a position of support 38 relative to guide rod 22.

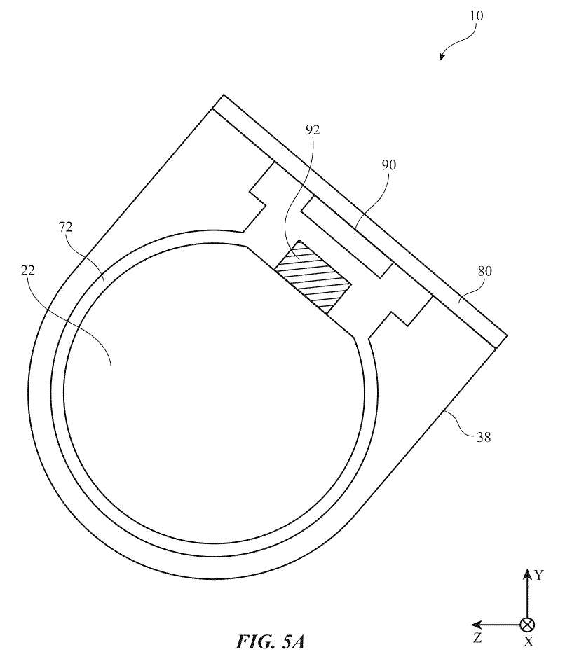

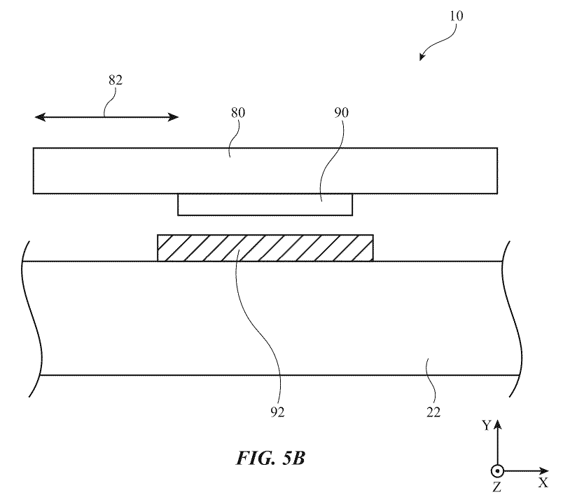

In some embodiments, instead of or in addition to measuring the position of an optical module relative to a guide rod using a potentiometer and/or a pressure sensor, a magnetic encoder may be used. An illustrative example is shown in FIG. 5A.

FIG. 5A is a side view (and/or a cross-sectional side view) of an interior portion of device 10 showing guide rod 22 in opening 72 of support 38. Magnetic encoder 90 may be used to determine a support 38 relative to guide rod 22. In particular, magnetic encoder 90 may be coupled to circuit board 80. Magnetic encoder 90 may be a hall effect sensor or other suitable magnetic sensor. Corresponding magnet 92 may be coupled to guide rod 22. In some embodiments, magnet 92 may be a permanent magnet, such as a rare earth magnet. Magnet 92 may be coupled to a surface of guide rod 22, such as using adhesive or another suitable attachment.

In operation, as support 38 (and optical module 20 of FIGS. 1 and 2) moves relative to guide rod 22, magnetic encoder 90 may pass over magnet 92. The magnetism of magnet 92 may be detected by magnetic encoder 90. Based on the measured magnetism (e.g., based on the magnetic encoder measurements), a position of support 38 (and optical module 20) relative to guide rod 22 may be determined. An illustrative front view showing the relationship between support 38, guide rod 22, and magnetic encoder 90 is shown in FIG. 5B.

As shown in FIG. 5B, circuit board 80, which is coupled to support 38 (FIG. 3A), may move in directions 82 relative to guide rod 22. Directions 82 may correspond with the +X and -X directions. As circuit board 80 and support 38 move in directions 82, magnetic encoder 90 may pass over magnet 92. As magnetic encoder 90 passes over magnet 92, the magnetism measured by magnetic encoder 90 will change based on the location of magnetic encoder 90 relative to magnet 92. Based on the magnetic encoder measurements, a position of support 38 (and optical module 20 of FIGS. 1 and 2) relative to guide rod 22 may be determined. In this way, a magnetic encoder (e.g., a magnetic sensor) may be used to determine a position of an optical module relative to the guide rod.

Although FIGS. 5A and 5B show a single magnetic encoder 90 on circuit board 80, this is merely illustrative. Multiple magnetic encoders 90 may be on circuit board 80 and/or otherwise coupled to support 38 to determine a position of support 38 relative to guide rod 22.

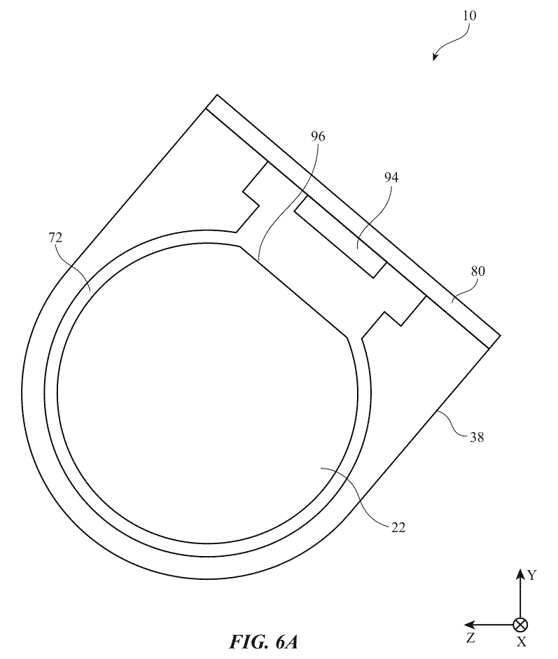

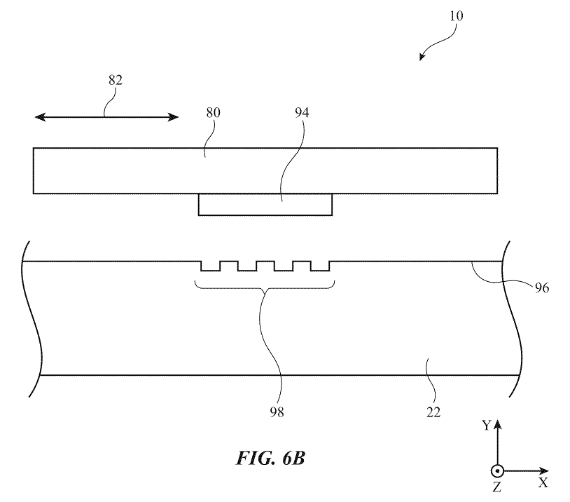

In some embodiments, instead of or in addition to measuring the position of an optical module relative to a guide rod using a potentiometer, a pressure sensor, and/or a magnetic encoder, an optical sensor may be used. An illustrative example is shown in FIG. 6A.

FIG. 6A is a side view (and/or a cross-sectional side view) of an interior portion of device 10 showing guide rod 22 in opening 72 of support 38. Optical sensor 94 may be used to determine a support 38 relative to guide rod 22. In particular, optical sensor 94 may be coupled to circuit board 80. Optical sensor 94 may be an optical encoder or other suitable optical sensor, and may include a light source (e.g., a light-emitting diode) and/or a light sensor (e.g., a photodetector). In some embodiments, optical sensor 94 may emit light using the light source and detect reflected light using the light sensor. In other embodiments, optical sensor 94 may detect light from a scene without emitting light (e.g., if optical sensor 94 is an image sensor). Surface 96 of guide rod 22 may include an optical pattern. The optical pattern may be, for example, a pattern etched on surface 96 (e.g., using a laser or other suitable etching tool).

In operation, as support 38 (and optical module 20 of FIGS. 1 and 2) moves relative to guide rod 22, optical sensor 94 may pass over the pattern on surface 96. The pattern on surface 96 may be detected by optical sensor 94. Based on the measured optical pattern (e.g., based on measurements of the optical pattern), a position of support 38 (and optical module 20) relative to guide rod 22 may be determined. An illustrative front view showing the relationship between support 38, guide rod 22, and optical sensor 94 is shown in FIG. 6B.

As shown in FIG. 6B, circuit board 80, which is coupled to support 38 (FIG. 3A), may move in directions 82 relative to guide rod 22. Directions 82 may correspond with the +X and -X directions. As circuit board 80 and support 38 move in directions 82, optical sensor 94 may pass over optical pattern 98 on surface 96. As optical sensor 94 passes over optical pattern 98, the measurements of optical sensor 94 will change based on the location of optical sensor 94 relative to optical pattern 98. Based on the measurements, a position of support 38 (and optical module 20 of FIGS. 1 and 2) relative to guide rod 22 may be determined. In this way, an optical sensor may be used to determine a position of an optical module relative to the guide rod.

In the example of FIG. 6B, optical pattern 98 includes multiple rectangular etches (e.g., recesses) in guide rod 22. However, these etches are merely illustrative. In general, etches of any suitable shape may be formed in guide rod 22 to form optical pattern 98. Alternatively or additionally, protrusions may be formed on guide rod 22 to form optical pattern 98 and/or a patterned coating may be formed on guide rod 22 to form optical pattern 98.

Although FIGS. 6A and 6B show a single optical sensor 94 on circuit board 80, this is merely illustrative. Multiple optical sensors 94 may be on circuit board 80 and/or otherwise coupled to support 38 to determine a position of support 38 relative to guide rod 22.

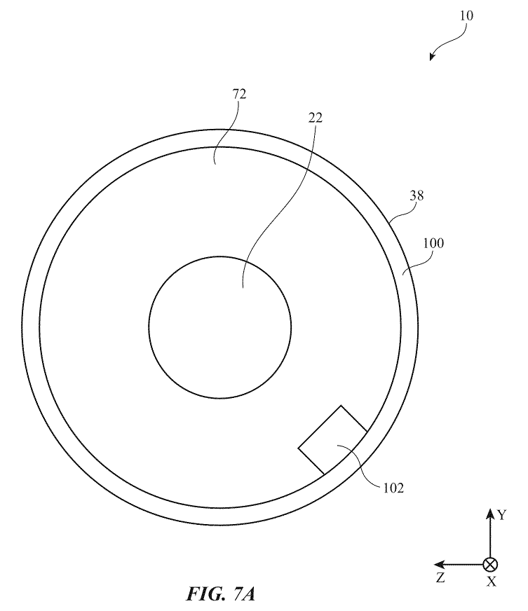

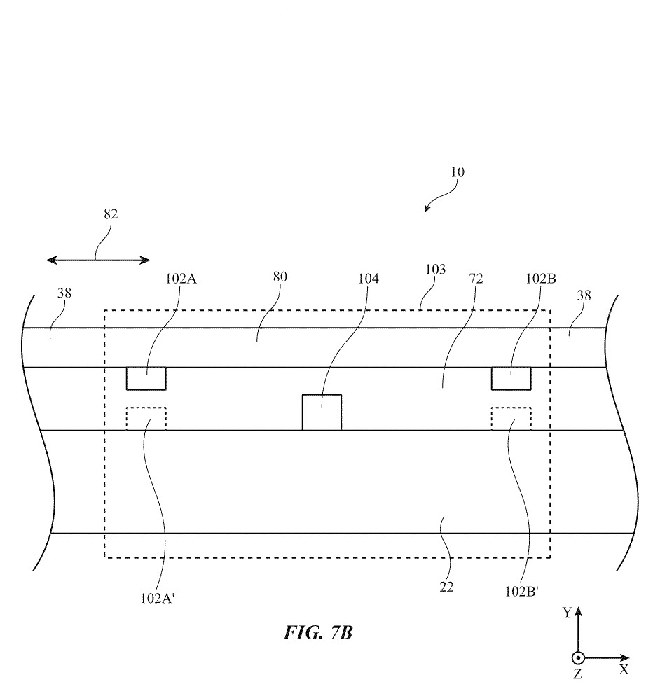

In some embodiments, instead of or in addition to measuring the position of an optical module relative to a guide rod using a potentiometer, a pressure sensor, a magnetic encoder, and/or an optical sensor, a pneumatic pressure sensor may be used. An illustrative example is shown in FIG. 7A.

FIG. 7A is a side view (and/or a cross-sectional side view) of an interior portion of device 10 showing guide rod 22 in opening 72 of support 38. One or more pneumatic pressure sensors 102 may be used to determine a support 38 relative to guide rod 22. In particular, pneumatic pressure sensor(s) 102 may be coupled to support 38 (e.g., to one or more circuit boards 80 coupled to support 38 – see FIG. 3A). Pneumatic pressure sensor(s) 102 may measure the pressure within opening 72. Seal 100 may be coupled to support 38 and surround opening 72. Seal 100 may be a gasket, such as a polymer gasket, that partially or entirely seals opening 72.

An illustrative front view showing the relationship between support 38, guide rod 22, and pneumatic pressure sensors 102 is shown in FIG. 7B. Pneumatic pressure sensors 102A and 102B may be formed within air gap formed by opening 72 in sealed portion 103. In particular, pneumatic pressure sensors 102A and 102B may be formed on circuit board 80. In operation, circuit board 80, which is coupled to support 38, may move in directions 82 relative to guide rod 22. Directions 82 may correspond with the +X and -X directions. As support 38 moves relative to guide rod 22, pneumatic pressure sensors 102A and 102B will sense different pneumatic pressures (e.g., because of sealed portion 103 of the air gap formed by opening 72, as well as optional protrusions from guide rod 22, such as protrusion 104). In this way, the position of support 38 relative to guide rod 22 may be determined by measuring the pneumatic pressure changes within the air gap formed by opening 72.

Instead of, or in addition to, including pneumatic pressure sensors 102A and 102B on circuit board 80/support 38, the pneumatic pressure sensors may be formed on guide rod 22, as shown by positions 102A’ and 102B’. In these embodiments, a protrusion, such as protrusion 104, may be formed on circuit board 80/support 38, or may be formed on guide rod 22.

In general, device 10 may include any suitable number of pneumatic pressure sensors 102 within sealed portion 103, such as at least one pressure, at least two pressure sensors, or at least four pressure sensors, as examples. Alternatively or additionally, device 10 may include multiple sealed portions 103 between support 38 and guide rod 22, if desired.

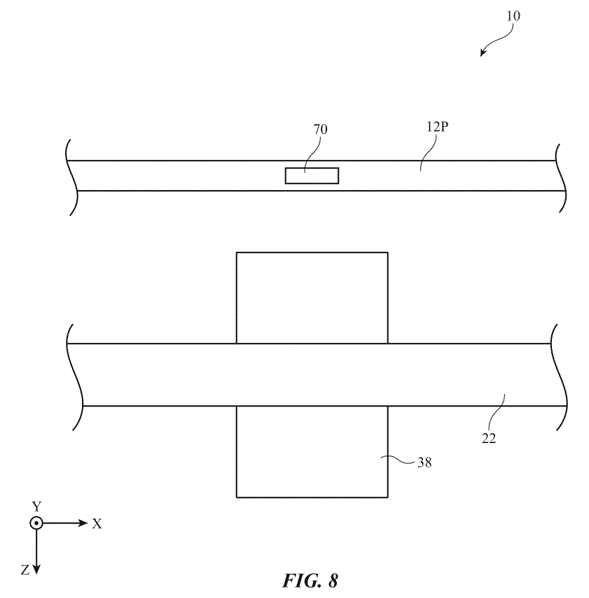

Although FIGS. 2-7 have shown and described incorporating a sensor on, in, or relative to guide rod 22, this is merely illustrative. In general, a sensor, such as a potentiometer, a pressure sensor, a magnetic encoder, an optical sensor, and/or a pneumatic pressure sensor may be formed on, in, or adjacent to any suitable fixed portion of device 10. An illustrative example is shown in FIG. 8.

As shown in FIG. 8, sensor 70 may be incorporated in a fixed portion (e.g., fixed in position relative to the other components within device 10) of device 10, such as in fixed portion 12P of housing 12 (FIG. 1). Fixed portion 12P may be a chassis of device 10, a housing of device 10 (e.g., main portion 12M of FIG. 1), and/or another suitable fixed portion of device 10. In some embodiments, fixed portion 12P may be a rigid or stiff portion of device 10. Sensor 70 may determine a position of support 38 as support 38 moves along guide rod 22 as described in connection with FIGS. 2-7.

Although FIG. 8 shows sensor 70 in fixed portion 12P of housing 12, sensor 70 may additionally or alternatively be incorporated into or onto support 38. In some embodiments, sensor 70 may be formed on support 38, and may detect a portion of fixed portion 12P (e.g., a resistor on fixed portion 12P as described in connection with the potentiometer of FIGS. 3A and 3B, a protrusion on fixed portion 12P as described in connection with the pressure sensor of FIGS. 4A and 4B, a magnet on fixed portion 12P as described in connection with the magnetic encoder of FIGS. 5A and 5B, an optical pattern on fixed portion 12P as described in connection with the optical sensor of FIGS. 6A and 6B, and/or a portion of a pneumatic pressure sensor system as described in connection with FIGS. 7A and 7B).

In general, a single electronic device 10 may include one or more of the position sensors shown and described in connection with FIGS. 2-8 alone or in any combination.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. A head-mounted device, comprising:
a head-mounted housing;
guide rods coupled to the head-mounted housing, each guide rod including at least a portion of a position sensor; and
optical assemblies, wherein each optical assembly includes:
a lens
a display that is configured to provide an image to an eye box through the lens, and
a support for the lens, display, and sensor, wherein the support of each optical assembly is configured to slide along at least a respective one of the guide rods, and the position sensor of the respective one of the guide rods is configured to determine a position of the optical assembly relative to the respective one of the guide rods.

2. The head-mounted device of claim 1, wherein the position sensor comprises a potentiometer.

3. The head-mounted device of claim 2, wherein each rod includes a groove, and the potentiometer includes a fixed portion in the groove.

4. The head-mounted device of claim 3, wherein the potentiometer further includes a wiper that is coupled to the support and that is configured to contact the fixed portion, the potentiometer is configured to measure changes in potential as the wiper moves across the fixed portion as the optical assembly moves relative to the guide rod, and the position sensor is configured to determine the position of the optical assembly relative to the respective one of the guide rods based on the changes in the potential.

5. The head-mounted device of claim 1, wherein the position sensor comprises a pressure sensor.

6. The head-mounted device of claim 5, wherein the guide rod comprises a leaf spring, the pressure sensor is coupled to the support and is configured to contact the leaf spring, and the position sensor is configured to determine the position of the optical assembly relative to the respective one of the guide rods in based on measured pressure changes.

7. The head-mounted device of claim 1, wherein the position sensor comprises a magnetic encoder.

8. The head-mounted device of claim 7, wherein the guide rod comprises a magnet, the magnetic encoder is coupled to the support and is configured to pass over the magnet, and the position sensor is configured to determine the position of the optical assembly relative to the respective one of the guide rods based on magnetic encoder measurements.

9. The head-mounted device of claim 1, wherein the position sensor comprises an optical sensor.

10. The head-mounted device of claim 9, wherein each the guide rod includes an optical pattern, the optical sensor is coupled to the support, and the position sensor is configured to determine the position of the optical assembly relative to the respective one of the guide rods based on measurements of the optical pattern.

11. The head-mounted device of claim 1, wherein the support is configured to surround the respective one of the guide rods, the support further comprises a seal that seals an air gap between the support and the respective one of the guide rods.

12. The head-mounted device of claim 11, wherein the position sensor comprises at least one pneumatic pressure sensor that is configured to measure pneumatic pressure changes in the air gap between the support and the respective one of the guide rods to determine the position of the optical assembly relative to the respective one of the guide rods.

13. A head-mounted device, comprising:
a head-mounted housing;
a support coupled to the head-mounted housing and configured to move relative to the head-mounted housing;
a display supported by the support;
a lens supported by the support;
a fixed portion coupled to the head-mounted housing; and
a position sensor coupled to the fixed portion, wherein the position sensor is configured to determine a position of the support as the support moves relative to the head-mounted housing.

14. The head-mounted device of claim 13, wherein the fixed portion comprises a guide rod, and the support is coupled to and configured to slide relative to the guide rod.

15. The head-mounted device of claim 14, wherein the position sensor is configured to determine the position of the support relative to the guide rod as the support slides relative to the guide rod.

16. The head-mounted device of claim 13, wherein the fixed portion comprises a portion of the head-mounted housing.

17. The head-mounted device of claim 16, wherein the fixed portion is a chassis of the head-mounted housing.

18. A head-mounted device, comprising:
a head-mounted housing;
a guide rod coupled to the head-mounted housing, wherein the guide rod comprises a potentiometer;
a support having an opening configured to receive the guide rod and to allow the support to slide along the guide rod, wherein the potentiometer is configured to determine a position of the support along the guide rod; and
a display supported by the support.

19. The head-mounted device of claim 18, wherein the guide rod includes a groove, and the potentiometer includes a fixed portion in the groove.

20. The head-mounted device of claim 19, wherein the potentiometer further includes a wiper that extends from the fixed portion to the support, and the potentiometer is configured to measure changes in potential as the support slides relative to the guide rod to determine the position of the support along the guide rod.
